(19) United States
(12) Patent Application Publication
(10) Pub. No.: US 2012/0180657 A1
(43) Pub. Date: Jul. 19, 2012

(54) METHOD FOR PRODUCING AT LEAST ONE GAS HAVING A LOW CO2 CONTENT AND AT LEAST ONE FLUID HAVING A HIGH CO2 CONTENT

(75) Inventors: Christian Monereau, Montpellier (FR); Claire Bourhy-Weber, Suresnes (FR); Frederick Lockwood, Paris (FR); Jean-Pierre Tranier, L'Hay Les Roses (FR); Marc Wagner, Maur Des Posses (FR)

(73) Assignee: L'Air Liquide Societe Anonyme Pour L'Etude Et L'Exploitation Des Procedes Georges Claude, Paris (FR)

(21) Appl. No.: 13/393,665

(22) PCT Filed: Sep. 2, 2010
(86) PCT No.: PCT/FR10/51825

§ 371 Date: Mar. 26, 2012

(30) Foreign Application Priority Data
Sep. 2, 2009 (FR) 0955972

(51) Int. Cl. B01D 53/00; B01D 53/14; B01D 53/02; B01D 53/22

(52) U.S. Cl. 95/45; 95/229; 95/90; 95/290

(57) ABSTRACT

The present invention relates to a process for producing at least one CO₂-lean gas and at least one CO₂-rich fluid. In particular, it relates to a process for capturing dioxide in a fluid containing at least one compound more volatile than carbon dioxide such as, for example, methane CH₄, oxygen O₂, argon Ar, nitrogen N₂, carbon monoxide CO, helium He and/or hydrogen H₂.

The present invention relates to a process for producing at least one CO₂-lean gas and at least one CO₂-rich fluid. In particular, it relates to a process for capturing dioxide in a fluid containing at least one compound more volatile than carbon dioxide such as, for example, methane CH₄, oxygen O₂, argon Ar, nitrogen N₂, carbon monoxide CO, helium He and/or hydrogen H₂.

This invention may be applied, in particular, to plants for producing electricity and/or steam from carbon-based fuels such as coal, hydrocarbons (natural gas, fuel oil, oil residues, etc.), municipal waste, and biomass but also to refinery gases, chemical plants, iron and steel plants or cement works, for the treatment of natural gas at the outlet of production wells. It could also be applied to the exhaust gases of transport vehicles or even to the flue gases of boilers that are used for heating buildings.

Carbon dioxide is a greenhouse gas which, when it is emitted into the atmosphere, may be a cause of global warming. In order to solve this environmental problem, one solution consists in capturing, that is to say producing, a fluid that is enriched in carbon dioxide which will be able to be sequestered more easily.

CO₂ liquefiers today use tubular heat exchangers and no heat exchangers exist that make it possible to treat high throughputs (greater than around 1000 tonnes/day). In the cryogenics field, plants for separating gases from the air use brazed aluminium heat exchangers, which are certainly compact but are relatively expensive (aluminium) and generate large pressure drops.

One objective of the present invention is to propose an improved process for capturing carbon dioxide from a fluid containing CO₂ and at least one compound more volatile than the latter, using one or more cryogenic heat exchangers capable of treating very high throughputs (of the order of a million of Nm³/h, with 1 Nm³ representing a cubic metre taken at a temperature of 0° C. and a pressure of 1 atmosphere), with small temperature differences and low pressure drops and a lower cost relative to conventional heat exchangers made of brazed aluminium.

The invention relates to a process for producing at least one CO₂-lean gas and one or more CO₂-rich fluids from a fluid to be treated containing CO₂ and at least one compound more volatile than CO₂, using at least the following steps:
a) cooling of said fluid to be treated; and
b) separation of said fluid cooled in step a) into said CO₂-lean gas and one or more CO₂-rich fluids;
   characterized in that at least one portion of the cooling carried out in step a) takes place by heat exchange with at least one fraction of said CO₂-lean gas, in one or more regenerative heat exchangers and in that said step a) comprises the following sub-steps:
a1) division of said fluid to be treated into at least a first and a second flow;
a2) cooling of said first flow in said regenerative heat exchangers by heat exchange with at least one fraction of the CO₂-lean gas obtained in step b) resulting in a cooled first flow and cooling of said second flow in a multi-fluid heat exchanger by heat exchange with at least one portion of the CO₂-rich fluids obtained in step b) resulting in a cooled second flow; and
a3) reuniting at least said cooled first flow and said cooled second flow in order to form a cooled third flow, said third flow being sent to said separation step b).

The fluid to be treated generally originates from a boiler or any installation that produces flue gases. The flue gases may have undergone several pretreatments, especially to remove the NOₓ (nitrogen oxides), dusts, SOₓ (sulphur oxides) and/or water.

Before the separation, the fluid to be treated is either a single-phase fluid, in gas or liquid form, or a multi-phase fluid. It contains CO₂ that it is desired to separate from the other constituents of said fluid. These other constituents comprise at least one or more compounds more volatile than carbon dioxide in the sense of the condensation, for example methane CH₄, oxygen O₂, argon Ar, nitrogen N₂, carbon monoxide CO, helium He and/or hydrogen H₂. The fluids to be treated generally comprise predominantly nitrogen, or predominantly CO or predominantly hydrogen. The CO₂ content may vary from a few hundreds of ppm (parts per million) of CO₂ to several tens of percent.

In step a), the fluid to be treated is generally cooled without changing state. The inventors have shown that it is particularly advantageous to achieve this cooling, at least partly, by heat exchange with at least one fraction of the CO₂-lean gas from the separation process that is the subject of step b), this being in one or more heat exchangers of regenerative type. Additionally, the cooling may be carried out in one or more other multi-fluid heat exchangers by heat exchange with CO₂-rich fluids from the separation process.

Step a) of cooling the fluid to be treated comprises three sub-steps. The first sub-step (step a1) consists in dividing this fluid into at least a first flow and a second flow. In the second sub-step (step a2), the first flow is sent into one or more regenerative heat exchangers cooled by passage of at least one fraction of the CO₂-lean fluid from step b) and the second flow is sent into one or more multi-fluid heat exchangers, through which at least one portion of the cold CO₂-rich fluids from step b) in particular travel. In the third sub-step (step a3), the first and second flows of fluid to be treated, once cooled, are reunited before being sent to step b).

Regenerative heat exchangers are heat exchangers where the hot fluid gives some of its energy to a matrix. The intermittent passage, hot fluid then cold fluid, over the matrix enables exchange of heat between the two fluids. Classed within this category of regenerators are rotating matrix heat exchangers and static or valve heat exchangers. These are compact heat exchangers with a large heat exchange area due to the porosity of the matrix. They are less expensive for an equivalent area and clog up less due to the alternating flushing. On the other hand, the mechanical movement of the matrix or the set of valves may lead to breakdowns and a partial mixing of the hot and cold fluids.

The rotary regenerator heat exchangers with rotating matrix exhibit two types of flow:
axial flow where the matrix is constituted of a disc, the axis of rotation of which is parallel to the flow;
radial flow where the matrix is constituted of a drum that rotates following an axis perpendicular to the flow.

In static (or valve) regenerator heat exchangers, the matrices are alternately passed through by hot and cold streams. These regenerators are very widespread in iron and steel mills or in the glass industry. The heat recovery from the flue gases exiting the glass melting furnace takes place with structured matrix static regenerators made of ceramic parts. Each exchanger is successively passed through by the hot flue gases and the combustion air to be preheated. The continuous heating of the glass bath is ensured by one group of regenerators per pair. The changeover of the two gases is periodic (inversion every thirty minutes approximately). On an industrial site, the total duration of a production run is between 4 and 12 years without stop. The materials used are therefore resistant to corrosion at high temperature. The regenerators are designed in order to prevent a too rapid clogging of the fluid passages. The assembly of the refractory parts of the storage matrix is perfectly structured.

In the present case, the matrix (internal parts) of the heat exchanger are periodically cooled by the passage of at least one portion of the CO₂-lean gas from the separation step b), then they are heated by the passage of the fluid to be treated. The heat exchange between the two fluids is indirect. The hot fluid transmits thermal energy to the matrix of the heat exchanger, whilst the cold fluid takes it, so that there is periodic regeneration of the heat exchanger. If a continuous heat exchange is desired, it is necessary to divide the heat exchanger into at least two sections according to methods known to those skilled in the art. While one section gives heat to the cold fluid that runs through it, the other section transfers heat to the fluid to be treated which runs through it, and the roles alternate.

Multi-fluid heat exchangers can be produced both with rotating matrices (multiple sections dedicated to each of the fluids) and with static matrices.

Thus, a portion of the cooling of the fluid to be treated carried out in step a) takes place in one or more regenerative heat exchangers, which makes it possible to reduce the pressure drops and therefore the energy consumed, and therefore to reduce the cost thereof. The expression “a portion of the cooling” means that a fraction of the heat to be given up in order to obtain the cooling in question is given up in one or more regenerative type heat exchangers. For this purpose, the fluid to be treated may be physically divided and one portion only is sent to the regenerative heat exchangers. It is also possible to carry out only one portion of the cooling-down in these regenerative heat exchangers. According to one particular embodiment, at least 75% of the heat transfer necessary for the cooling is carried out in the regenerative heat exchangers. This may be carried out by passing 75% by weight of the fluid to be treated into these heat exchangers.

Step b) comprises the low-temperature separation of the fluid to be treated after its cooling in step a). The low temperature is understood here to mean between 0° C. and −150° C. This separation is generally isobaric. This separation produces at least the CO₂-lean fluid which is used for the cooling carried out in step a), and also one or more CO₂)-rich fluids.

According to particular aspects of the present invention, the latter may have one or more of the following features:
said first flow obtained by division in sub-step al) represents at least 75% by weight fraction of said fluid to be treated.
added to said fraction of CO₂-lean gas sent into said regenerative heat exchangers is a given fluid.
said regenerative heat exchangers are fixed matrix and radial circulation regenerative heat exchangers.
said regenerative heat exchangers contain quartz beads.
said step b) is of liquid or solid cryocondensation, absorption, adsorption, and/or permeation type. These types of separation may be carried out separately or in combination with one another.
said regenerative heat exchangers are composed of materials compatible with mercury.

Advantageously, the fraction of fluid to be treated cooled in one or more regenerative heat exchangers, that is to say the first flow of fluid to be treated mentioned above, represents at least 75% by weight of the fluid to be treated. This fraction is preferably adapted to the flow of CO₂-lean gas sent into the regenerative heat exchangers so as to minimize the temperature differences in the heat exchangers in question. According to one particular embodiment, all of the fluid to be treated is cooled in one or more regenerative heat exchangers.

In order to improve the exchange in the regenerative heat exchangers, it is possible to add an external fluid, which might be available, to the CO₂-lean gas prior to its introduction into the regenerative heat exchangers. Preferably, this additional fluid is itself a CO₂-lean fluid. Its temperature is preferably between that of the CO₂-lean gas from step b) and that of the fluid to be treated or of the first flow from step a1).

The radial bed has low pressure drops for high volume flow rates to be treated. Quartz beads are one example of a material that can be used for the matrix, compatible with the presence of mercury in the fluid to be treated and inexpensive.

The separation step b) may be of various types. In particular, it may be a liquid or solid cryocondensation. Solid cryocondensation consists in solidifying initial gaseous CO₂ by bringing the fluid to be treated to a temperature below the triple point of CO₂, while the partial pressure of CO₂ in the fluid to be treated is below that of the triple point of CO₂. For example, the total pressure of the fluid to be treated is close to atmospheric pressure. This solidification operation is sometimes called “desublimation” or “anti-sublimation” of CO₂ and by extension of the fluid to be treated.

Certain compounds more volatile than CO₂ are not solidified and remain in the gaseous state. With the unsolidified CO₂, these compounds constitute said CO₂-lean gas, that is to say gas that comprises less than 50% of CO₂ by volume and preferably less than 10% CO₂ by volume. According to one particular embodiment, said CO₂-lean gas comprises more than 1% of CO₂ by volume. According to another particular embodiment, it comprises more than 2% thereof. According to another particular embodiment, it comprises more than 5% thereof. It forms a solid that comprises predominantly CO₂, that is to say at least 90% by volume relative to the gaseous state, preferably at least 95% by volume and more preferably still at least 99% of CO₂ by volume.

This solid may contain compounds other than CO₂. Mention may be made, for example, of other compounds which could also be solidified, or else bubbles and/or drops of fluid set within said solid. This explains that the solid may not be purely constituted of solid CO₂. This “solid” may comprise non-solid portions such as fluid inclusions (drops, bubbles, etc.).

This solid is then isolated from the unsolidified compounds after the cryocondensation and recovered. Next, it is brought to temperature and pressure conditions such that it changes to a liquid and/or gaseous fluid state. Therefore, a liquefaction of at least one portion of said solid may take place. This thus gives rise to one or more CO₂-rich primary fluids. These fluids are said to be “primary” in order to distinguish them from the process fluids which are said to be “secondary”. The expression “CO₂-rich” should be understood to mean “comprising predominantly CO₂” within the meaning defined above.

Liquid cryocondensation consists in liquefying initially gaseous CO₂ by bringing the fluid to be treated to a low temperature but by preferably remaining at a temperature above that of the triple point of CO₂, while the partial pressure of the CO₂ in the fluid to be treated is greater than that of the triple point of CO₂.

Step b) may also comprise an absorption process (for example with methanol), an adsorption process (TSA, PSA, VPSA, VSA, PTSA, etc. type processes) and/or a permeation process (for example with polymer type membranes).

The invention also relates to an installation comprising one or more heat exchangers connected at the inlet by lines to a fluid source, a CO₂ separation unit connected at the inlet by lines to outlets of said heat exchangers, characterized in that at least one of said heat exchangers is of the regenerative type and that it is connected at the inlet by lines to an outlet of said separation unit.

Said separation unit is of liquid or solid cryocondensation, absorption, adsorption and/or permeation type. These types of separation may be carried out separately or in combination with one another.

The connections via lines may comprise components of the following type: valves, heat exchangers, capacitors, that do not modify the chemical nature of the flows transported, and also by-passes (flow divisions or flow additions).

The invention also relates to the use of an installation as described above for producing at least one CO₂-lean gas and one or more CO₂-rich fluids from a fluid to be treated provided by said source containing CO₂ and at least one compound more volatile than CO₂.

Unlike conventional heat exchangers, regenerative heat exchangers do not need to be constructed of brazed aluminium in order to be effective in terms of heat exchange. This constitutes a substantial advantage when elemental mercury (Hg) or compounds thereof are present in the fluid to be treated. This is the case, for example, when the fluid to be treated originates from the combustion of coal or of certain heavy oil products. Indeed, it is then necessary to remove the mercury present in the fluids seen by a heat exchanger made of aluminium, this material being corroded by mercury. This operation is no longer necessary for a heat exchanger for which the materials are compatible with mercury, that is to say are not corroded under the operating conditions of the heat exchanger. According to the invention, at least one portion of the exchange carried out in step a) is carried out in one or more regenerative heat exchangers, preferably that are compatible with mercury, so that there is less mercury to be extracted. It is no longer necessary to remove the mercury if all the fluid to be treated passes through regenerative heat exchangers.

The invention will be better understood on reading the description and examples that follow, which are not limiting. They refer to the appended drawings, in which:

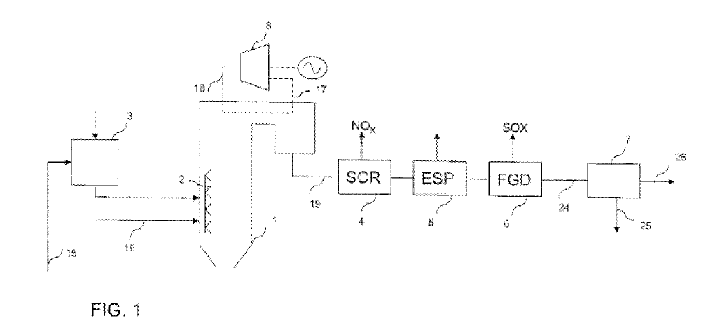

FIG. 1 shows a coal-based electricity generation plant with flue gas purification units; and

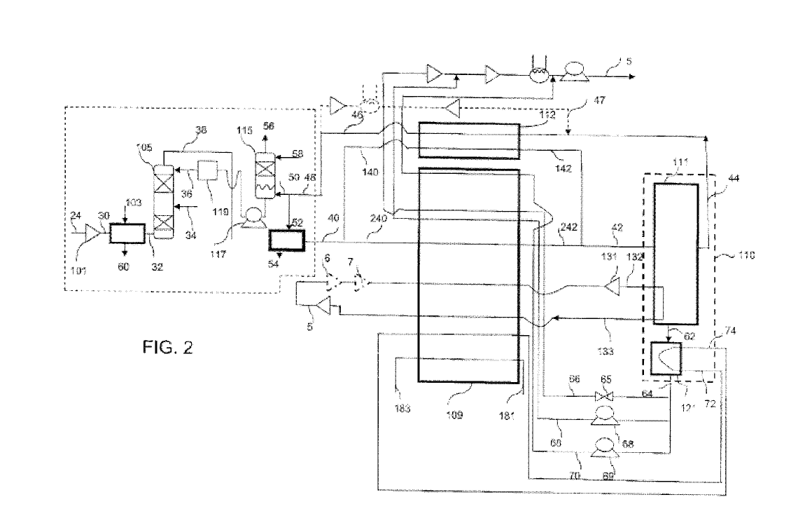

FIG. 2 shows a unit for low-temperature CO₂ purification of the flue gases according to the invention.

FIG. 1 is a schematic view of a plant for generating electricity from coal. A flow of primary air 15 passes through the units 3 where the coal 14 is pulverized and conveyed to the burners of the boiler 1. A flow of secondary air 16 is supplied directly to the burners in order to provide additional oxygen necessary for an almost complete combustion of the coal. Water 17 is sent to the boiler 1 in order to produce steam 18 which is expanded in a turbine 8 and condensed in a condenser 9. Flue gases 19 containing nitrogen, CO₂, water vapour and other impurities undergo several treatments in order to remove some of said impurities. The unit 4 removes the NOₓ, for example by catalysis in the presence of ammonia. The unit 5 removes the dust, for example by an electrostatic precipitator and the unit 6 is a desulphurization system for removing SO₂ and/or SO₃. The units 4 and 6 may be superfluous depending on the composition of the required product. The purified flow 24 coming from the unit 6 (or 5 if 6 is not present) is sent to a unit 7 for low-temperature purification by cryocondensation in order to produce a relatively pure CO₂ flow 25 and a nitrogen-rich residual flow 26. This unit 7 is also known as a CO₂ capture unit.

FIG. 2 is a schematic view of the compression and purification unit 7 from FIG. 1. The following components are present:
compression of the flue gas fluid 24 in a compressor 101 in particular for compensating for the pressure drops over the various equipment of the unit: this compression may be carried out upstream (in this case, it may also be combined with boiler compression, known as boiler draught), between 2 pieces of equipment or downstream of the unit 7;
fine filtration 103 of the fluid 30 to levels of less than 1 mg/m³ of solid particles, preferably of less than 100 μg/m³ with dust elimination 60;
cooling of the fluid 32 to a temperature close to 0° C. (between 0° C. and 10° C.) so as to condense the water vapour that it contains: this cooling may be carried out by direct contact (for example, tower with injection of water at two levels, cold water 36 and water at a temperature close to ambient temperature 34 with or without packing), or indirect contact;
unit 107 for removing residual water vapour, for example:
   adsorption on fixed beds, fluidized beds and/or rotary drier, the adsorbant possibly being activated alumina, silica gel or a molecular sieve (3A, 4A, 5A, 13X, etc.)
   cryocondensation in a direct or indirect contact heat exchanger;
cooling of the fluid 40 in a heat exchanger 109 where the fluid is cooled to a temperature close to but preferably above the solidification temperature of CO₂ situated in the vicinity of −100° C. if the CO₂ content of the fluid is around 15% and the pressure close to atmospheric pressure;
the heat exchanger 109 is divided into several parallel heat exchangers, in particular by having a heat exchanger 112 in which a large fraction of the fluid 40 exchanges with a large fraction of the fluid 44;
the heat exchanger 112 is of regenerative type, preferably in the following configurations:
   rotary heat exchanger
   fixed bed heat exchanger, in particular having radial beds in which the cold fluid goes back inside.

Furthermore, it may be sought to increase the flow of 46 in order to balance the heat exchange with all of the fluid 40 or to adapt the fraction of fluid 40 so as to balance the heat exchange with all fluid 46.

It is also possible to use a rotary type heat exchanger in order to carry out the heat exchange which makes it possible to supply cold to the process fluid (42) below the cryocondensation temperature of CO₂ (typically around −100° C. for gas containing around 15% CO₂ by volume).

Rotary heat exchangers enable a particularly effective heat exchange, with a reduced heat exchanger volume, between two fluids of similar pressure and composition. As large amounts of heat are exchanged in the CO₂ cryocondensation process, an optimization of the process requires an optimization of this step by seeking to reduce the cost (less volume and less expensive materials and pressure drops while retaining reasonable temperature differences.
Heat exchanger 111 for solid cryocondensation of at least one portion of the CO₂ contained in the fluid 42 so as to produce a CO₂-depleted fluid 44 for example at a temperature of around −120° C.; this temperature is chosen as a function of the targeted capture rate; with such a temperature, the content in the fluid 44 is around 1.5%, i.e. a capture rate of 90%; in this heat exchanger solid CO₂ 62 is produced; this heat exchanger may correspond to several types of process and technology:
   heat exchanger for continuous solid cryocondensation in which solid CO₂ is produced in the form of carbon dioxide snow which is extracted, for example by a screw and which is pressurized in order to introduce it into a bath of liquid CO₂ 121 at a pressure above that of the triple point of CO₂; this pressurization may also be carried out in “batch mode” in a system of silos; this continuous solid cryocondensation may be carried out in the following technologies:
   scraped-surface heat exchanger, the scrapers being, for example, in the form of screws so as to favour the extraction of the solid;
   fluidized bed heat exchanger so as to convey the carbon dioxide snow and clean the tubes with particles, for example, having a density greater than that of the carbon dioxide snow;
   heat exchanger with extraction of solid by vibrations, ultrasounds, pneumatic or thermal effect (intermittent heating so as to the dropping of the carbon dioxide snow);
   accumulation on a smooth surface, with periodic “natural” dropping into a tank;
heat exchanger for “batch mode” solid cryocondensation; in this case, several heat exchangers in parallel are alternately used in order to carry out the solid cryocondensation of CO₂ then isolated, pressurized to a pressure above that of the triple point of CO₂ so as to liquefy the solid CO₂ and optionally partially vaporize it;
the fluid 46 is heated in the heat exchanger 109 then optionally divided into 2 portions, one for regenerating the unit for removing residual steam, the other (optional) for producing cold water by evaporation in a direct contact tower by introducing a dry fluid 50 which will be saturated with water by vaporizing a portion thereof;
a cycle with isentropic expansion turbine(s) producing cold between −100 and −120° C. for the solid cryocondensation and between −56° C. and −100° C. in order to top up the lack of refrigerants in this part of the heat exchanger 109; this cycle may be with an auxiliary fluid that is rich in argon or nitrogen or may even be a fraction of the fluid 48.
A liquid CO₂ bath, 121, into which the solid CO₂ 62, is poured. The bath contains a device for ensuring the heat exchange with the fluid 74 which could be, for example, pure CO₂.
The solid CO₂ melts in the bath, and the latent heat and also the sensible heat are discharged by the fluid 72.
The refrigerants in the fluid 72 may then be used elsewhere in the process.
The components 111 and 121 together form a separation unit that produces a CO₂-lean gas 44 and several CO₂-rich fluids 66, 68, 70.
the vaporization of liquid CO₂ tops up the provision of cold between 0° C. and −56° C. at different pressure levels (for example at two levels, fluids 66 and 68), the fluid 70 being pressurized at a pressure such that it does not vaporize and therefore exchanges only sensible heat.

1-7. (canceled)

8. A process for producing at least one CO₂-lean gas and one or more CO₂-rich fluids from a first fluid containing CO₂ and at least one compound more volatile than CO₂, comprising the following steps:
a) cooling said first fluid; and
b) separating said first fluid cooled in step a) into said CO₂-lean gas and one or more CO₂-rich fluids;
wherein at least part of the cooling carried out in step a) takes place by heat exchange with at least one fraction of said CO₂-lean gas, in one or more regenerative heat exchangers and wherein step a) comprises the following sub-steps:
a1) dividing said first fluid into at least a first and a second flow;
a2) cooling of said first flow in said regenerative heat exchangers by heat exchange with at least one fraction of the CO₂-lean gas obtained in step b) resulting in a cooled first flow and cooling of said second flow in a multi-fluid heat exchanger by heat exchange with at least one portion of the CO₂-rich fluids obtained in step b) resulting in a cooled second flow; and
a3) reuniting at least said cooled first flow and said cooled second flow in order to form a cooled third flow, said third flow being sent to said separation step b).

9. The process of claim 8, wherein said first flow obtained by division in sub-step a1) represents at least 75%, by weight fraction, of said first fluid.

10. The process of claim 8, wherein added to said fraction of CO₂-lean gas sent into said regenerative heat exchangers is a given fluid.

11. The process of claim 8, wherein said regenerative heat exchangers are fixed matrix and radial circulation regenerative heat exchangers.

12. The process of claim 11, wherein said regenerative heat exchangers contain quartz beads.

13. The process of claim 8, wherein in step b) is of liquid or solid cryocondensation, absorption, adsorption and/or permeation type.

14. The process of claim 8, wherein said regenerative heat exchangers are composed of materials compatible with mercury.
